(19) United States
(12) Patent Application Publication
(10) Pub. No.: US 2009/0206183 A1
(43) Pub. Date: Aug. 20, 2009

(54) FUEL INJECTOR

(76) Inventors: Nadja Eisenmenger, Stuttgart (DE); Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/305,072

(22) PCT Filed: Jun. 4, 2007
(86) PCT No.: PCT/EP2007/055441

§ 371 Date: Dec. 16, 2008

(30) Foreign Application Priority Data
Jul. 24, 2006 (DE) 10 2006 034 112.0

(51) Int. Cl. B05B 1/30

(52) U.S. Cl. 239/584

(57) ABSTRACT

The invention relates to a fuel injector with an injector housing (6) comprising a pressure chamber (15), from which, depending on the pressure in a control chamber (22), pressurized fuel is injected into a combustion chamber of an internal combustion engine when the pressure in the control chamber (22) with the aid of a control valve device (12) is reduced so far, that a nozzle needle (10) opens. In order to present a fuel injector, constructed in a simple and cost efficient way, the pressure chamber (15) is sealed at an end away from the combustion chamber with a valve piece (30) having a sealing face or sealing edge facing away from the combustion chamber and lying against the injector housing (6).

### PRIOR ART

For introducing fuel into direct-injection diesel engines, stroke-controlled fuel injectors can be used, in which the injection pressure can be adapted to the load and the rpm. For controlling the pressure in the control chamber, magnet valves or piezoelectric valves can be used.

### DISCLOSURE OF THE INVENTION

The object of the invention is to create a fuel injector as generically defined by the preamble to claim 1 that is constructed simply and can be produced economically.

In a fuel injector, having an injector housing that includes a pressure chamber, from which, as a function of the pressure in a control chamber, fuel subjected to high pressure is injected into a combustion chamber of an internal combustion engine when the pressure in the control chamber is lowered, with the aid of a control valve device, so far that a nozzle needle opens, this object is attained in that the pressure chamber is closed off on its end remote from the combustion chamber by a valve piece that has a sealing face or sealing edge, remote from the combustion chamber, that rests with sealing action on the injector housing, in order to form a sealing seat. The disposition according to the invention of the valve piece offers the advantage that the hydraulic pressure prevailing in the pressure chamber can be used for keeping the valve piece, by sealing action, in contact with the injector housing.

A preferred exemplary embodiment of the fuel injector is characterized in that the valve piece has a pressure clamber portion, which is disposed in the pressure chamber. The pressure chamber portion of the valve piece is subjected to the hydraulic pressure prevailing in the pressure chamber.

A further preferred exemplary embodiment of the fuel injector is characterized in that a valve piston of the control valve device is guided in the valve piece. The valve piston is preferably embodied in pressure-balanced fashion.

A further preferred exemplary embodiment of the fuel injector is characterized in that the valve piston rests, with its end toward the combustion chamber, on a control piece which in rests on the valve piece. Preferably, the valve piston has a sealing edge, which rests as a flat seat on the control piece.

A further preferred exemplary embodiment of the fuel injector is characterized in that the end remote from the combustion chamber of the nozzle needle is guided in the control piece and defines the control chamber in the control piece. Preferably, the control piece is kept in contact with the valve piece by the spring force of a spring assembly and/or by the hydraulic pressure prevailing in the pressure chamber.

A further preferred exemplary embodiment of the fuel injector is characterized in that the valve piston has a pressure relief connection. Preferably, the valve piston has a central through hole, which discharges, inside the sealing seat, at the end toward the combustion chamber of the valve piston and is in communication with a pressure relief chamber.

A further preferred exemplary embodiment of the fuel injector is characterized in that a valve seat of the control valve device is embodied on the end remote from the combustion chamber of the valve piece. The valve piece is embodied as a ball seat, conical seat, or flat seat, for example.

A further preferred exemplary embodiment of the fuel injector is characterized in that the end remote from the combustion chamber of the nozzle needle is guided in the valve piece and defines the control chamber. As a result, the construction and assembly of the fuel injector are simplified.

A further preferred exemplary embodiment of the fuel injector is characterized in that the nozzle needle includes two fragments, which are coupled with one another. The fragments can be coupled with one another mechanically or hydraulically.

A further preferred exemplary embodiment of the fuel injector is characterized in that the valve piece and/or the control piece has at least one connection that connects the pressure chamber to a pressure compartment or connects the pressure chamber or the pressure compartment to the control chamber. Preferably, the connection is equipped with a throttle restriction.

Further advantages, characteristics and details of the invention will become apparent from the ensuing description, in which various exemplary embodiments are described in detail in conjunction with the drawings.

### BRIEF DESCRIPTION OF THE DRAWINGS

Shown are:

FIG. 1, a schematic illustration of a fuel injector according to the invention in longitudinal section, in accordance with a first exemplary embodiment;

FIG. 2, a similar fuel injector to FIG. 1, in a second exemplary embodiment; and

FIG. 3, a detail of a fuel injector in a further exemplary embodiment, in longitudinal section.

### DESCRIPTION OF THE EXEMPLARY EMBODIMENTS

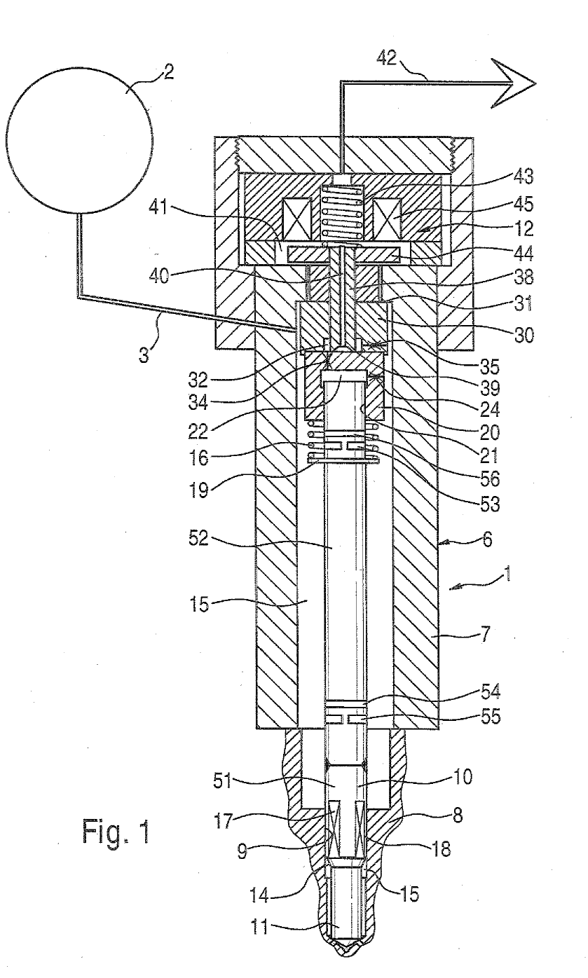

In FIG. 1, a fuel injector 1 is shown schematically in longitudinal section. The fuel injector 1 is supplied with fuel that is at high pressure from a high-pressure reservoir 2. Via a supply line 3, the fuel injector 1 is connected to the high-pressure reservoir 2.

The fuel injector 1 includes an injector housing 6, with an injector body 7 and a nozzle body 8 that has a central guide bore 9. In the guide bore 9, a nozzle needle 10 is guided movably back and forth. The nozzle needle 10 has a tip 11, on which a sealing face is embodied that forms a sealing seat on the end of the nozzle body 8 that protrudes into the combustion chamber. When the nozzle needle seat is closed at the tip 11 of the nozzle needle 10, then a plurality of injection ports in the nozzle body 8 are closed. When the nozzle needle tip 11 lifts from its seat, then fuel subjected to high pressure is injected through the injection ports into the combustion chamber of the internal combustion engine.

The opening motion of the nozzle needle 10 is controlled by a control valve 12, which is also called a metering valve.

A pressure shoulder 14 is embodied on the nozzle needle 10 and is disposed in a pressure chamber 15 that extends in the nozzle body 8 and the injector body 7. The nozzle needle 10 is prestressed with its tip 11 against the nozzle body 8 by a compression spring 16. Flat faces 17, 18 are embodied on the nozzle needle 10, which enable the passage of fuel from the part of the pressure chamber 15 that is provided in the injector body 7 into the part of the pressure chamber 15 in which the pressure shoulder 14 is disposed.

A spring cup 19 or collar 19 is attached to the nozzle needle 10. The compression spring 16 is fastened between the spring cup 19 and a control piece 20 that has a guide bore 21 for the end remote from the combustion chamber of the nozzle needle 10. The end face remote from the combustion chamber of the nozzle needle 10 defines a control chamber 22 in the control piece 20. The control chamber 22 is in communication with the pressure chamber 15 via a connection conduit 24, which has a throttle restriction. The end remote from the combustion chamber of the control piece 20 rests on the end toward the combustion chamber of a valve piece 30, forming a scaling seat. The valve piece 30 in turn rests on the injector body 7, forming a sealing seat 31.

A pressure compartment 32 is recessed out of the end face toward the combustion chamber of the valve piece 30 and is in communication with the control chamber 22 via a connection conduit 34, which is provided in the valve piece 20 and is equipped with a throttle restriction. The pressure compartment 32 is in communication with the pressure chamber 15 via a further connection conduit 35, which is provided in the valve piece 30 and is equipped with a throttle restriction.

In an axial through hole in the valve piece 30, a valve piston 38 is guided movably back and forth. The end toward the combustion chamber of the valve piston 38 rests, forming a sealing seat 39, on the end face remote from the combustion chamber of the control piece 20. A central through hole 40, which is provided in the valve piston 38, discharges inside the sealing seat 39. On its end remote from the combustion chamber, the central through hole 40 discharges into a pressure relief chamber 41, which as indicated by an arrow 42 is in communication with a fuel storage container (not shown).

The valve piston 38 is prestressed toward the combustion chamber by a spring 43, so that the sealing seat 39 provided on the end toward the combustion chamber of the valve piston 38 is closed. A magnet armature 44, which cooperates with an electromagnet 45, is secured to the end remote from the combustion chamber of the valve piston 38. When current is supplied to the electromagnet 45, the magnet armature 44 is attracted toward the electromagnet 45, so that the sealing seat 39 on the end toward the combustion chamber of the valve piston 38 opens. When the sealing seat 39 opens, then the pressure compartment 32, and the control chamber 22 as well via the connection conduit 34, are pressure-relieved. As a result of this pressure relief on the end remote from the combustion chamber of the nozzle needle 10, the nozzle needle tip 11 lifts from its seat at the nozzle body 8, so that fuel is injected into the combustion chamber.

The nozzle needle 10 of the fuel injector 1 shown in FIG. 1 includes one nozzle portion 51 toward the combustion chamber, which is joined by material engagement to a nozzle needle portion 52 remote from the combustion chamber. To avoid stresses on the nozzle needle 10 from production inaccuracies, thin compensation ribs 53 through 56, which act like a cardan joint, are provided in the nozzle needle portion 52. As an alternative to a long nozzle needle 10, a two-piece combination nozzle needle and control rod can be used, in which the nozzle needle and the control rod are joined to one another either mechanically or hydraulically.

The connection conduit 24 acts as an inflow conduit for the control chamber 22. The associated throttle restriction is also called an inflow throttle restriction. The connection conduit 34 acts as an outflow conduit. The associated throttle restriction is also called an outflow throttle restriction. The connection conduit 35 with the associated throttle restriction is optional and, upon closure of the nozzle needle 10, it enables filling of the control chamber 22 via the outflow throttle restriction in the outflow conduit 34 as well. As a result, the closing speed of the nozzle needle 10 can be increased. Still other spring and retention elements can also be provided, in order to fix the valve piece 30 in its position of repose.

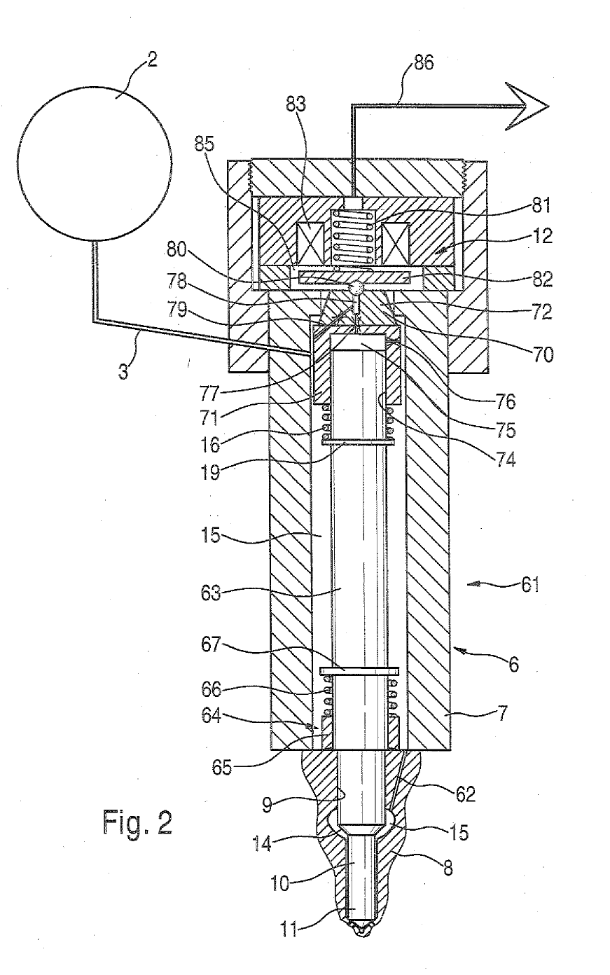

In FIG. 2, a fuel injector 61 similar to the fuel injector 1 of FIG. 1 is shown schematically in longitudinal section. The same reference numerals are used to identify identical parts. To avoid repetition, see the above description of FIG. 1. Below, it is primarily the differences between the two exemplary embodiments that will be discussed.

In the fuel injector 61 shown in FIG. 2, the part of the pressure chamber 15 in which the pressure shoulder 14 is disposed is in communication, via a pressure connection conduit 62, with the part of the pressure chamber 15 that is disposed in the injector body 7. The nozzle needle 10 is equipped with a nozzle needle extension 62, which is coupled to the nozzle needle 10 with the aid of a hydraulic coupler 64. The hydraulic coupler 64 includes a coupler sleeve 65, in which the end toward the combustion chamber of the nozzle needle extension 63 is guided. The coupler sleeve 65 is prestressed against the nozzle body 8 with the aid of a spring 66, which is braced on a collar 67 of the nozzle needle extension 63.

The fuel injector 61 shown in FIG. 2 includes a control valve 12 with a valve piece 70. The valve piece 70 has a guide portion 71, toward the combustion chamber, and a sealing portion 72, remote from the combustion chamber. In the guide portion 71, the valve piece 70 has a guide bore 74, in which the end remote from the combustion chamber of the nozzle needle 10, or of the nozzle needle extension 63, is guided.

The end face remote from the combustion chamber of the nozzle needle 10 or nozzle needle extension 63 defines a control chamber 75 in the valve piece 70. The control chamber 75 is in communication with the pressure chamber 15 via a connection conduit 76, which is equipped with a throttle restriction. The control chamber 75 is in communication, via a further connection conduit 77, which is likewise equipped with a throttle restriction, with a pressure compartment 78, which has the form of a blind bore, and from which a further a connection conduit 79, which is likewise equipped with a throttle restriction, extends into the pressure chamber 15.

The blind bore forming the pressure compartment 78 is closed on its end remote from the combustion chamber by a valve ball 80. The valve ball 80 is kept in contact with the opening, remote from the combustion chamber, of the pressure compartment 78 by the prestressing force of a spring 81. Between the spring 81 and the valve ball 80 is a magnet armature 82, to which the valve ball 80 is secured. The magnet armature 82 cooperates with an electromagnet 83 and is disposed in a pressure relief chamber 85. The pressure relief chamber 85, as indicated by an arrow 86, is in communication with a fuel storage container.

In the state of repose, the control valve 12 embodied as a ball valve is closed. When the electromagnet 83 is supplied with current, then the magnet armature 82, with the valve ball 80, is attracted toward the electromagnet 83, so that the valve ball 80 lifts from its associated valve seat on the end remote from the combustion chamber of the pressure compartment 78. The pressure compartment 78 and, via the connection conduit 77, the control chamber 75 are thereupon relieved, so that the nozzle needle 10, with its tip 11, lifts from the associated valve seat.

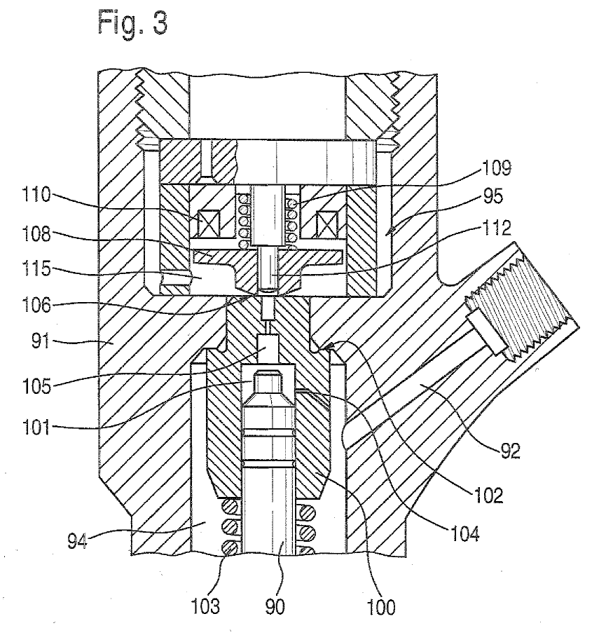

In FIG. 3, a further exemplary embodiment is shown in section. A nozzle needle 90 is disposed in an injector housing 91, which is supplied via a supply line 92 with fuel that reaches a pressure chamber 94 in the interior of the injector housing 91. The opening and closure of the nozzle needle 90 are controlled by a valve device 95, which includes a valve piece 100. The valve piece 100 is inserted into the injector housing 91 by its end toward the combustion chamber and seals off from the injector housing via a flat sealing seat 102. The sealing seat 102 is kept closed by a spring 103.

In the valve piece 100, a control chamber 101 is embodied, which is defined by the end remote from the combustion chamber of the nozzle needle 90. The control chamber 101 is in communication with the pressure chamber 94 via a connection conduit 104, which has a throttle restriction. The control chamber 101 is also in communication, via a further connection conduit 105, which is likewise equipped with a throttle restriction, with a chamber which is defined inside a sealing seat 106 by a magnet armature 108. The magnet armature 108 is prestressed against the valve piece 100 by a spring 109, so that the sealing seat 106 is closed. When the magnet armature 108 is actuated by an electromagnet 110, the sealing seat 106 is then opened. A compensation piston 112 is received in the magnet armature 108. When the sealing seat 106 is opened, then a communication from the control chamber 101 into a pressure relief chamber 115 is opened up via the connection conduit 105.

1-10. (canceled)

11. A fuel injector, having
an injector housing
a pressure chamber disposed in the housing, which is connected to a control chamber, such that fuel subjected to high pressure is injected into a combustion chamber of an internal combustion engine when pressure in the control chamber is lowered;
a control valve device affecting the pressure in the control chamber to open or close a nozzle needle;
a valve piece having a sealing face or sealing edge, remote from the combustion chamber, wherein the valve piece rests with sealing action on the injector housing so that pressure chamber is closed off on its end remote from the combustion chamber

12. The fuel injector as defined by claim 11, wherein the valve piece has a pressure chamber portion, which is disposed in the pressure chamber.

13. The fuel injector as defined by claim 11, wherein a valve piston of the control valve device is guided in the valve piece.

14. The fuel injector as defined by claim 12, wherein a valve piston of the control valve device is guided in the valve piece.

15. The fuel injector as defined by claim 13, wherein the valve piston rests, with its end toward the combustion chamber, on a control piece which in turn rests on the valve piece.

16. The fuel injector as defined by claim 14, wherein the valve piston rests, with its end toward the combustion chamber, on a control piece which in turn rests on the valve piece.

17. The fuel injector as defined by claim 15, wherein the end remote from the combustion chamber of the nozzle needle is guided in the control piece and defines the control chamber in the control piece.

18. The fuel injector as defined by claim 16, wherein the end remote from the combustion chamber of the nozzle needle is guided in the control piece and defines the control chamber in the control piece.

19. The fuel injector as defined by claim 13, wherein the valve piston has a pressure relief connection.

20. The fuel injector as defined by claim 15, wherein the valve piston has a pressure relief connection.

21. The fuel injector as defined by claim 17, wherein the valve piston has a pressure relief connection.

22. The fuel injector as defined by claim 11, wherein a valve seat of the control valve device is embodied on the end remote from the combustion chamber of the valve piece.

23. The fuel injector as defined by claim 12, wherein a valve seat of the control valve device is embodied on the end remote from the combustion chamber of the valve piece.

24. The fuel injector as defined by claim 11, wherein the end remote from the combustion chamber of the nozzle needle is guided in the valve piece and defines the control chamber.

25. The fuel injector as defined by claim 12, wherein the end remote from the combustion chamber of the nozzle needle is guided in the valve piece and defines the control chamber.

26. The fuel injector as defined by claim 22, wherein the end remote from the combustion chamber of the nozzle needle is guided in the valve piece and defines the control chamber.

27. The fuel injector as defined by claim 11, wherein the nozzle needle includes two fragments, which are coupled with one another.

28. The fuel injector as defined by claim 11 wherein the valve piece and/or the control piece has at least one connection that connects the pressure chamber to a pressure compartment or connects the pressure chamber or the pressure compartment to the control chamber.
